(19) United States
(12) Patent Application Publication
(10) Pub. No.: US 2020/0327079 A1
(43) Pub. Date: Oct. 15, 2020

(54) DATA PROCESSING METHOD AND DEVICE, DMA CONTROLLER, AND COMPUTER READABLE STORAGE MEDIUM

(71) Applicant: SZ DJI TECHNOLOGY CO., LTD., Shenzhen (CN)

(72) Inventors: Yao ZHAO, Shenzhen (CN); Sijin LI, Shenzhen (CN); Feng HAN, Shenzhen (CN)

(21) Appl. No.: 16/914,738

(22) Filed: Jun. 29, 2020

Related U.S. Application Data
(63) Continuation of application No. PCT/CN2017/120247, filed on Dec. 29, 2017.

(51) Int. Cl. G06F 13/28; G06N 3/08; G06F 9/345; G06K 9/62

(52) U.S. Cl. CPC G06F 13/28; G06K 9/6232; G06F 9/3455; G06N 3/08

(57) ABSTRACT

The present disclosure provides a data processing method for a direct memory access (DMA) controller. The method includes acquiring feature information of two or more original output feature maps, and generating DMA read configuration information and DMA write configuration information of the original output feature maps based on the feature information of each original output feature map; and reading input data from the original output feature map based on the DMA read configuration information of the original output feature map, and storing the read input data to a target output feature map based on the DMA write configuration information of the original output feature map for each original output feature map.

### CROSS-REFERENCE TO RELATED APPLICATION

This application is a continuation of International Application No. PCT/CN2017/120247, filed on Dec. 29, 2017, the entire content of which is incorporated herein by reference.

### TECHNICAL FIELD

The present disclosure relates to the field of image processing technology and, more specifically, to a data processing method and device, a direct memory access (DMA) controller, and a computer readable storage medium.

### BACKGROUND

In machine learning, a convolutional neural network (CNN) is a type of a feed-forward neural network, and its artificial neurons can respond to a part of the surrounding cells in a coverage area, which has excellent performance for large-scale image processing. CNN is a multilayer neural network. Each layer is composed of multiple two-dimensional planes, and each plane is composed of multiple independent neurons. In general, a CNN can include a convolutional layer and a pooling layer. The convolution layer can be used to extract various features of the image, and the pooling lay can be used to extract the features of the original feature signal twice to reduce the feature resolution, which can greatly reduce the training parameters and reduce the degree of model overfitting. In addition, CNN can reduce the complexity of the network with its special structure of local weight sharing. In particular, the feature of being able to directly input multi-dimensional input vector images to the network can avoid the complexity of data reconstruction during feature extraction and classification, therefore, it is used widely.

CNN involves a variety of data movement tasks, and the data movement tasks can be implemented by a central processing unit (CPU). However, the data movement efficiency is low, which adds an excessive burden to the CPU.

### SUMMARY

One aspect of the present disclosure provides a data processing method for a direct memory access (DMA) controller. The method includes acquiring feature information of two or more original output feature maps, and generating DMA read configuration information and DMA write configuration information of the original output feature maps based on the feature information of each original output feature map; and reading input data from the original output feature map based on the DMA read configuration information of the original output feature map, and storing the read input data to a target output feature map based on the DMA write configuration information of the original output feature map for each original output feature map.

Another aspect of the present disclosure provides a data processing method for a direct memory access (DMA) controller. The method includes dividing an original input feature map into two or more sub-input feature maps; acquiring feature information of each sub-input feature map and generating DMA read configuration information and DMA write configuration information of the sub-input feature map based on the feature information of each sub-input feature map; and reading input data from the sub-input feature map based on the DMA read configuration information of the sub-input feature map and storing the read input data to a target input feature map corresponding to the sub-input feature map based on the DMA write configuration information of the sub-input feature map for each sub-input feature map. Different sub-input feature maps correspond to different target input feature maps.

Another aspect of the present disclosure provides a data processing method for a direct memory access (DMA) controller. The method includes dividing an original input feature map into two or more sub-input feature maps; generating first DMA read configuration information and first DMA write configuration information of the sub-input feature map based on feature information of each sub-input feature map; reading input data from the sub-input feature map based on the first DMA read configuration information of the sub-input feature map, and storing the read input data in a target input feature map corresponding to the sub-input feature map based on the first DMA write configuration information of the sub-input feature map for each sub-input feature map; generating second DMA read configuration information and second DMA write configuration information of the target input feature map based on feature information of each target input feature map; and reading the input data from the target input feature map based on the second DMA read configuration information of the target input feature map, storing the read input data in the target output feature map based on the second DMA write configuration information of the target input feature map for each target input feature map. Different sub-input feature maps correspond to different target input feature maps.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIGS. 1A-1G are diagrams of the working principle of a DMA controller according to an embodiment of the present disclosure.

FIGS. 2A-2C are diagrams of performing a concatenation operation on an original output feature map according to an embodiment of the present disclosure.

FIGS. 3A-3C are diagrams of performing a slice operation on an original input feature map according to an embodiment of the present disclosure.

FIGS. 4A-4D are diagrams of performing a dilate convolution operation on the original input feature map according to an embodiment of the present disclosure.

FIG. 5 is a block diagram of a data processing device according to an embodiment of the present disclosure.

### DETAILED DESCRIPTION OF THE EMBODIMENTS

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure. In addition, in the situation where the technical solutions described in the embodiments are not conflicting, they can be combined.

The terms used in the one or more implementations of the present specification are merely for illustrating specific implementations, and are not intended to limit the one or more implementations of the present specification. The terms “a”, “said”, and “the” of singular forms used in the one or more implementations of the present specification and the appended claims are also intended to include plural forms, unless otherwise specified in the context clearly. It should also be understood that the term “and/or” used in the present specification indicates and includes any or all possible combinations of one or more associated listed items.

t should be understood that although terms “first”, “second”, “third”, etc. may be used in the one or more implementations of the present specification to describe various types of information, the information is not limited to the terms. These terms are used to differentiate information of the same type. For example, without departing from the scope of the one or more implementations of the present specification, the first information can also be referred to as the second information, and similarly, the second information can also be referred to as the first information. Depending on the context, for example, the word “if” used here can be explained as “while”, “when”, or “in response to determining”.

An embodiment of the present disclosure provides a data processing method, which can be applied to a DMA controller. In the CNN, data can be moved by the DMA controller, such that there is no need to implement data movement by using the CPU, thereby reducing the burden of the CPU, moving the data more efficiently, and accelerating the CNN operation.

The DMA controller is a peripheral that can move data inside a system, allowing data exchange between hardware devices of different speeds. The data movement operation does not depend on the CPU. The DMA controller can indicate that the data to be processed by the CPU is in place by using a DMA interrupt. In addition, the CPU only needs to establish a DMA transfer, respond to the DMA interrupt, and process the data that the DMA controller moves to an internal memory.

For a single DMA transfer process, one source address, one destination address, and a stride length can be specified, where the stride length can be stride information. After the end of each write operation, the sum of the current address and the stride length may be the next address to be processed. This type of transmission with a normal stride length is called a 1D transmission.

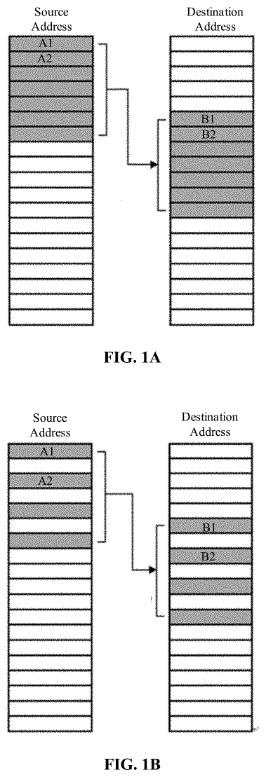

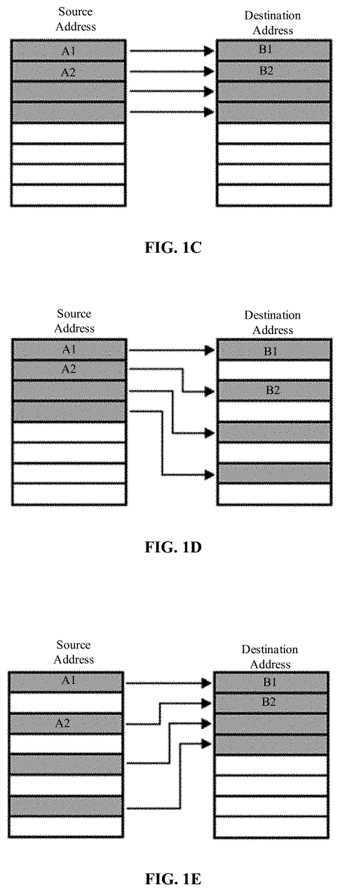

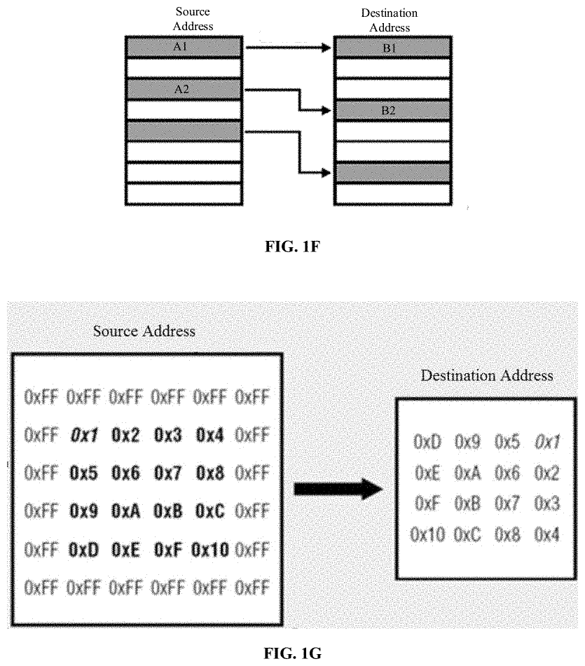

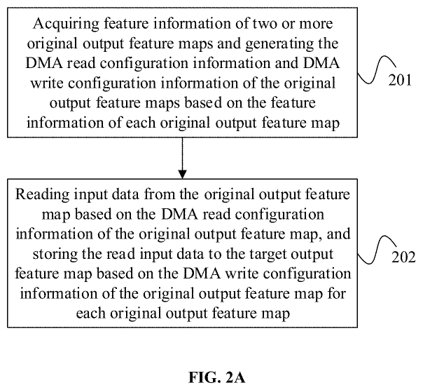

Referring to FIG. 1A, after the DMA controller reads data from a first source address A1, the DMA controller may write the data to a first destination address B1. Subsequently, the source address A1 may be added to the stride length 1 to obtain a second source address A2, and the destination address B1 may be added to the stride length 1 to obtain a second destination address B2. Similarly, after the DMA controller reads data from the source address A2, the DMA controller may write the data to the destination address B2.

Referring to FIG. 1B, after the DMA controller reads data from the first source address A1, the DMA controller may write the data to the first destination address B1. Subsequently, the source address A1 may be added to the stride length 2 to obtain the second source address A2, and the destination address B1 may be added to the stride length 2 to obtain the second destination address B2. Similarly, after the DMA controller reads data from the source address A2, the DMA controller may write the data to the destination address B2.

Compared with FIG. 1A, in FIG. 1B, the normal stride length 1 can be modified to an abnormal stride length 2 such that 1D transmission can skip certain addresses and increase the flexibility of the 1D transmission.

A 2D transmission is an extension of the 1D transmission and is widely used in the field of image processing. In the 2D transmission process, the variables involved may include X-direction count configuration (X_COUNT), X-direction stride configuration (X_STRIDE), Y-direction count configuration (Y_COUNT), and Y-direction stride configuration (Y_STRIDE).

The 2D transmission is a nested loop. The parameters of the inner loop can be determined by the X-direction count configuration and the X-direction stride configuration. The parameters of the outer loop can be determined by the Y-direction count configuration and the Y-direction stride configuration. In addition, the 1D transmission may correspond to the inner loop of the 2D transmission. The X-direction stride configuration can determine the stride length of the address increase each time x is incremented; the Y-direction stride configuration can determine the stride length of the address increase each time y is incremented; the X-direction count configuration can determine the number of x increments; and the Y-direction count configuration can determine the number of y increments. Further, the Y-direction stride configuration can be negative to allow the DMA controller to roll back the address in the buffer.

Referring to FIG. 1C to FIG. 1G, which are diagrams of the application scenarios of 1D-to-1D, 1D-to-2D, 2D-to-1D, and 2D-to-2D. It should be apparent that the 2D transmission process describe above can enrich the application scenarios of the DMA.

A 3D transmission is a further extension of the 1D transmission and the variables involved may include the X-direction count configuration (X_COUNT), X-direction stride configuration (X_STRIDE), Y-direction count configuration (Y_COUNT), Y-direction stride configuration (Y_STRIDE), Z-direction count configuration (Z_COUNT), and Z-direction stride configuration (Z_STRIDE). In particular, the 3D transmission is a triple nested loop, in which the parameters of the inner loop can be determined by the X-direction count configuration and the X-direction stride configuration, the parameters of the middle loop can be determined by the Z-direction count configuration and the Z-direction stride configuration, and the parameters of the outer loop can be determined by the Y-direction count configuration and the Y-direction stride configuration.

In addition, the X-direction stride configuration can determine the stride length of the address increase each time x is incremented; the Y-direction stride configuration can determine the stride length of the address increase each time y is incremented; and the Z-direction stride configuration can determine the stride length of the address increase each time z is incremented. Further, the X-direction count configuration can determine the number of x increments; the Y-direction count configuration can determine the number of y increments, and the Z-direction count configuration can determine the number of z increments. Further, the Z-direction stride configuration can be negative to allow the DMA controller to roll back the address in the buffer.

The following description describes the above process with an example of a 2D-to-2D matrix extraction and rotation by 90°. Referring to FIG. 1G, assume that the source matrix may be stored in row order and the starting address may be A, and the destination matrix may be stored in row order and the starting address may be A′. As such, in the data reading process, the source address may be A+7, the X-direction count may be configured as 4, the X-direction stride may be configured as 1, the Y-direction count may be configured as 4, the Y-direction stride may be configured as 3, the Z-direction count may be configured as 0, and the Z-direction stride may be configured as 0. In the data writing process, the source address may be A′+3, the X-direction count may be configured as 4, the X-direction stride may be configured as 4, the Y-direction count may be configured as 4, the Y-direction stride may be configured as −13, the Z-direction count may be configured as 0, and the Z-direction stride may be configured as 0

Referring to FIG. 1G, the DMA controller can read data from the source address 0X1 (i.e., the starting address of A+7) and write the read data to the destination address 0X1 (i.e., the starting address of A′+3). Further, the DMA controller can read data from the source address 0X2 (i.e., 0X1+X-direction stride configuration 1) and write the read data to the destination address 0X2 (i.e., 0X1+X-direction stride configuration 4). Furthermore, the DMA controller can read data from the source address 0X3 and write the read data to the destination address 0X3. In addition, the DMA controller can read data from the source address 0X4 and write the read data to the destination address 0X4.

In the process described above, in the data reading process, the data has been read 4 times in the X-direction, that is, the X-direction count configuration of 4 has been reached, as such, Y can be executed once. Since the Y stride is configured as 3, 3 may be added to the source address 0X4 to obtain the source address 0X5. In the data writing process, the data has been read 4 times in the X-direction, that is, the X-direction count configuration of 4 has been reached, as such, Y can be executed once. Therefore, 13 may be subtracted from the destination address 0X4 to obtain the destination address 0X5. In summary, the data may be read from the source address 0X5 and the read data may be write to the destination address 0X5. Subsequently, the data may be read from the source address 0X6 and the read data may be write to the destination address 0X6. Further, the data may be read from the source address 0X7 and the read data may be write to the destination address 0X7. In addition, the data may be read from the source address 0X8 and the read data may be write to the destination address 0X8.

After the above processing, in the data reading process, the data has been read 4 times in the X-direction, that is, the X-direction count configuration of 4 has been reached, as such, Y can be executed once. In the data writing process, the data has been read 4 times in the X-direction, that is, the X-direction count configuration of 4 has been reached, as such, Y can be executed once, and so on. Therefore, the effect may be as shown in FIG. 1G.

It can be understood from the above description that if the X-direction count configuration (X_COUNT), X-direction stride configuration (X_STRIDE), Y-direction count configuration (Y_COUNT), and Y-direction stride configuration (Y_STRIDE), Z-direction count configuration (Z_COUNT), and Z-direction stride configuration (Z_STRIDE) are provided, the DMA controller can use the above parameters to complete the data processing. That is, the DMA controller may use the parameters of the data reading process to read data from the source address, and use the parameter of the data writing process to write data to the destination address.

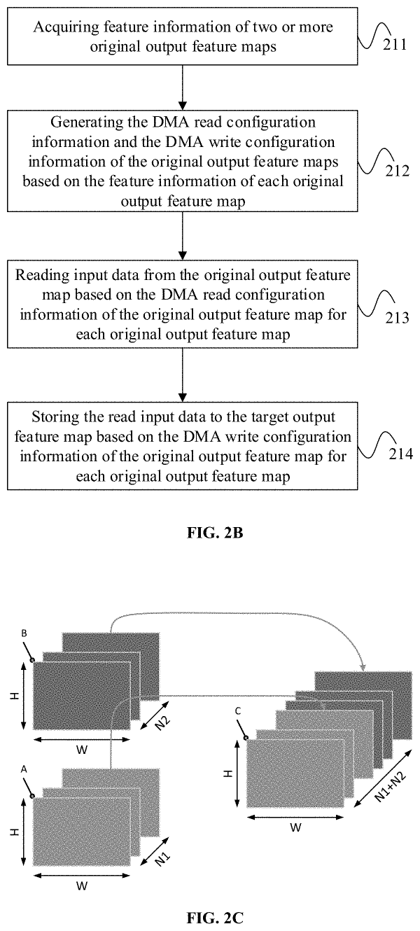

In a CNN, instead of using the CPU to implement the data movement task, the DMA controller can be used to implement the data movement task. As shown in FIG. 2, which is an example of a flowchart of the data processing method describe above in a CNN. The data processing method can be applied to a DMA controller. The data processing method is described in detail below.

201, acquiring feature information of two or more original output feature maps and generating the DMA read configuration information (for reading the data in the original output feature map) and DMA write configuration information (for writing the data to the target output feature maps) of the original output feature maps based on the feature information of each original output feature map.

202, reading input data from the original output feature map based on the DMA read configuration information of the original output feature map, and storing the read input data to the target output feature map based on the DMA write configuration information of the original output feature map for each original output feature map.

In the above example, the original output feature map may be an initial feature map, and the DMA controller can read data from the original output feature map. That is, the original output feature map can be used as the source data. In addition, the target output feature map may be a target feature map, and the DMA controller can write data to the target output feature map. In summary, the DMA controller can read data from the original output feature map and write the data into the target output feature map.

In particular, the DMA write information may be DMA configuration information used to store input data to the target output feature map (i.e., the target output feature map of the initial structure, and the data of unwritten original output feature map in the initial state; the subsequent embodiments will introduce the construction process of the target output feature map). As such, the input data can be stored to the target output feature map based on the DMA write configuration information. The write process, that is, the process of writing data from the source address to the destination address (i.e., the target output feature map), may be used to move data from the original output feature map to the target output feature map to obtain a target output feature map that may meet the needs.

In the previous embodiment, the DMA read configuration information and the DMA write configuration information may include the X-direction count configuration (X_COUNT), the X-direction stride configuration (X_STRIDE), the Y-direction count configuration (Y_COUNT), the Y-direction stride configuration (Y_STRIDE), the Z-direction count configuration (Z_COUNT), and the Z-direction stride configuration (Z_STRIDE).

Based on the technical solution described above, in some embodiments of the present disclosure, the data movement in the CNN can be realized by the DMA controller, and the data movement in the CNN does not need to be realized by the CPU, thereby reducing the burden on the CPU and moving the data more efficiently, which may accelerate the CNN operations without losing flexibility.

The technical solution described above will be described in detail below in combination with a specific application scenario. In particular, this application scenario is related to the implementation of concatenation (i.e., the CNN connection layer). More specifically, a large-scale convolution kernel may provide a larger receptive field, however, the large-scale convolution kernel may include more parameters. For example, a 5×5 convolution kernel parameter may be 2.78 (25/9) times of a 3×3 convolution kernel parameter. As such, a plurality of continuous small convolutional layers may be used instead of a single large convolutional layer, which can reduce the number of weights while maintaining the receptive field range, and achieve the purpose of building a deeper network. The concatenation operation may be used to stitch the output feature maps (the original output feature map in the present disclosure) of these decomposed small convolutional layers into the final output feature map (the target output feature map in the present disclosure), and the final output feature map can be used as the input feature map of the next layer.

If the CPU is used to complete the task of stitching the output feature maps of the plurality of convolutional layers, the burden on the CPU will be greatly increased. As such, the DMA controller may be used to complete the stitching task of the output feature maps of the plurality of convolutional layers, thereby reducing the burden on the CPU. The process will be described in detail below with reference to FIG. 2B.

211, acquiring feature information of two or more original output feature maps.

In some embodiments, the feature information may include, but is not limited to, the width W and height H of the original output feature map. In addition, the feature information may further include the number of channels of the original output feature map N, that is, the number N.

In some embodiments, for the two or more original output feature maps, all original output feature maps may have the same width W, and all original output feature maps may have the same height H. In addition, the number of channels N of different original output feature maps may be the same or different. For example, the number of channels N of the original output feature map 1 may be N1, the number of channels N of the original output feature map 2 may be N2, and N1 and N2 may be the same or different.

For the ease of description, in the following description, two original output feature maps (i.e., the output feature maps) to be stitched will be used as an example for illustration. Further, assume that the width of the original output feature map 1 may be W, the height may be H, the number of channels may be N1, the original output feature map 1 may be continuously stored in the memory, and the starting address may be A; and the width of the original output feature map 2 may be W, the height may be H, the number of channels may be N2, the original output feature map 2 may be continuously stored in the memory, and the starting address may be B.

212, generating the DMA read configuration information and the DMA write configuration information of the original output feature maps based on the feature information of each original output feature map. For example, the DMA controller may generate the DMA read configuration information and the DMA write configuration information of the original output feature map 1 based on the feature information of the original output feature map 1. In addition, the DMA controller may generate the DMA read configuration information and the DMA write configuration information of the original output feature map 2 based on the feature information of the original output feature map 2.

In some embodiments, generating the DMA read configuration information of the original output feature map based on the feature information of the original output feature map may include using the DMA controller to generate the X-direct count configuration based on the width W of the original output feature map; generating the Y-direction count configuration based on the height H of the original output feature map; and generating the X-direction stride configuration and the Y-direction stride configuration based on a predetermined value (such as 1). In addition, the DMA controller may also generate the Z-direction count configuration based on the number of channels N; and the Z-direction step configuration based on a predetermined value.

For example, the DMA read configuration information may include the X-direction count configuration: W; Y-direction count configuration: H; X-direction stride configuration: 1; and Y-direction stride configuration: 1. In addition, the DMA read configuration information may further include the Z-direction count configuration: N; and Z-direction stride configuration: 1.

Of course, the DMA read configuration information provided above is merely an example of the present disclosure. The present disclosure does not limit the DMA read configuration information, and it can be configured based on experience. The present disclosure uses the DMA read configuration information described above as an example.

For example, the DMA read configuration information for the original output feature map 1 may include the X-direction count configuration: W; Y-direction count configuration: H; X-direction stride configuration: 1; Y-direction stride configuration; Z-direction count configuration: N1; and Z-direction stride configuration: 1. The DMA read configuration information for the original output feature map 2 may include the X-direction count configuration: W; Y-direction count configuration: H; X-direction stride configuration: 1; Y-direction stride configuration; Z-direction count configuration: N2; and Z-direction stride configuration: 1.

In some embodiments, generating the DMA write configuration information of the original output feature map based on the feature information of the original output feature map may include using the DMA controller to generate the X-direct count configuration based on the width W of the original output feature map; generating the Y-direction count configuration based on the height H of the original output feature map; and generating the X-direction stride configuration and the Y-direction stride configuration based on a predetermined value (such as 1). In addition, the DMA controller may also generate the Z-direction count configuration based on the number of channels N; and the Z-direction step configuration based on a predetermined value.

For example, the DMA write configuration information may include the X-direction count configuration: W; Y-direction count configuration: H; X-direction stride configuration: 1; and Y-direction stride configuration: 1. In addition, the DMA read configuration information may further include: Z-direction count configuration: N; and Z-direction stride configuration: 1.

Of course, the DMA write configuration information provided above is merely an example of the present disclosure. The present disclosure does not limit the DMA write configuration information, and it can be configured based on experience. The present disclosure uses the DMA write configuration information described above as an example.

For example, the DMA write configuration information for the original output feature map 1 may include the X-direction count configuration: W; Y-direction count configuration: H; X-direction stride configuration: 1; Y-direction stride configuration; Z-direction count configuration: N1; and Z-direction stride configuration: 1. The DMA write configuration information for the original output feature map 2 may include the X-direction count configuration: W; Y-direction count configuration: H; X-direction stride configuration: 1; Y-direction stride configuration; Z-direction count configuration: N2; and Z-direction stride configuration: 1.

213, reading input data from the original output feature map based on the DMA read configuration information of the original output feature map for each original output feature map. In some embodiments, the DMA controller may read each input data in the original output feature map the configuration information based on the DMA read configuration information of the original output feature map from the starting address corresponding to the original output feature map.

For example, the DMA controller may read each input data in the original output feature map 1 based on the DMA read configuration information of the original output feature map 1 from the starting address A of the original output feature map 1. Further, the DMA controller may read each input data in the original output feature map 2 based on the DMA read configuration information of the original output feature map 2 from the starting address B of the original output feature map 2.

214, storing the read input data to the target output feature map based on the DMA write configuration information of the original output feature map for each original output feature map. In some embodiments, the DMA controller may store each read input data to the target output feature map based on the DMA write configuration information of the original output feature map from the starting address of the input data in the target output feature map.

In some embodiments, the input data of different original output feature maps may have different starting addresses at the target output feature maps. For example, if there are two original output feature maps, the input data of the first original output feature map in the starting address of the target output feature map may be the starting address C of the target output feature map; and the starting address of the input data of the second original output feature map in the target output feature map may be C+W*H*N, where W, H, and N may be the width, height, and number of channels of the first original output feature map, respectively.

For example, the DMA controller may store each read input data to the target output feature map based on the DMA write configuration information of the original output feature map 1 starting from the starting address C of the target output feature map. Further, the DMA controller may store each read input data to the target output feature map based on the DMA write configuration information of the original output feature map 2 starting from the starting address C+W*H*N of the target output feature map.

For example, as shown in FIG. 2C, assume that the width of the target output feature map after stitching may be W, the height may be H, and the number of channels may be N1+N2, the target output feature map may be continuously stored in the memory, and the starting address may be C, then the concatenation operation of the two original output feature maps may be implemented in two steps. In the first step, the DMA controller may move the original output feature map 1 to the first half of the address space of the target output feature map, that is, write the data or the original output feature map 1 from the starting address C. In the second step, the DMA controller may move the original output feature map 2 to the second half of the address space of the target output feature map, that is, writing the data of the original output feature map 2 starting from the address C+W*H*N1. As such, by using the two-step moving operation, the concatenation function of stitching two original output feature maps into one target output feature map can be realized.

In some embodiments, before storing the read input data in the target output feature map, target DMA configuration information can also be generated based on the feature information of all the original output feature maps, and the target output feature map can be constructed based on the target DMA configuration information. The constructed target output feature map may be the target output feature map in an initial state, without data being written in the original output feature map. The target output feature map can be a specific feature map, or a feature map including all 0s or 1s. Further, in 214, the input data may be stored in the constructed target output feature map. After all the data is stored in the constructed target output feature map, the final target output feature map may be obtained.

In some embodiments, generating the target DMA configuration information based on the feature information of the original output feature maps may include using the DMA controller to generate the X-direction count configuration based on the width W of all original output feature maps, generate the Y-direction count configuration based on the height H of all original output feature maps, and generate the Z-direction count configuration based on the number of channels N of all original output feature maps. In addition, the DMA controller may further generate the X-direction stride configuration, the Y-direction stride configuration, and the Z-direction stride configuration based on a predetermined value (such as 1).

For example, an example of the target DMA configuration information may include the X-direction count configuration: W; Y-direction count configuration: H; Z-direction count configuration: M; X-direction stride configuration: 1; Y-direction stride configuration: 1; and Z-direction stride configuration: 1. In particular, M may be the sum of the number N of all original output feature maps. For example, when the number of channels of the original output feature maps 1 and 2 are N1 and N2, respectively, M may be N1+N2.

Of course, the target DMA configuration information provided above is merely an example. The present disclosure does not limit the target DMA configuration information, and it can be configured based on experience. The present disclosure uses the target DMA configuration information described above as an example.

In some embodiments, constructing the target output feature map based on the target DMA configuration information may include using the DMA controller to construct a target output feature map of the size W*H*M based on the target DMA configuration information, where the target output feature map may be all 0s, the starting address may be C, W may be the width of the original output feature map, H may be the height of the original output feature map, and M may be the sum of the number of channels of all original output feature maps.

In some embodiments, constructing the target output feature map based on the target DMA configuration information may include reading specific pattern information from a specific storage location, and constructing the target output feature map corresponding to the specific pattern information based on the target DMA configuration information. Further, constructing the target output feature map corresponding to the specific pattern information based on the target DMA configuration information may include constructing a target output feature map of all 0s based on the target DMA configuration information. Of course, a target output feature map of all 1s may also be constructed.

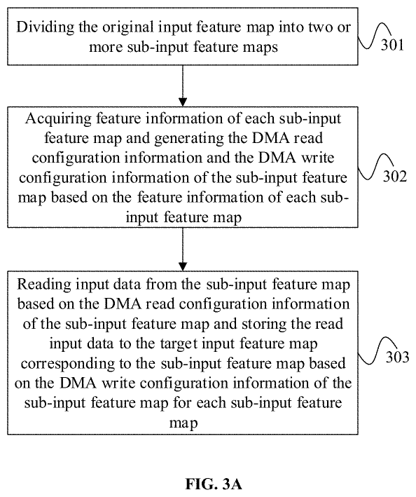

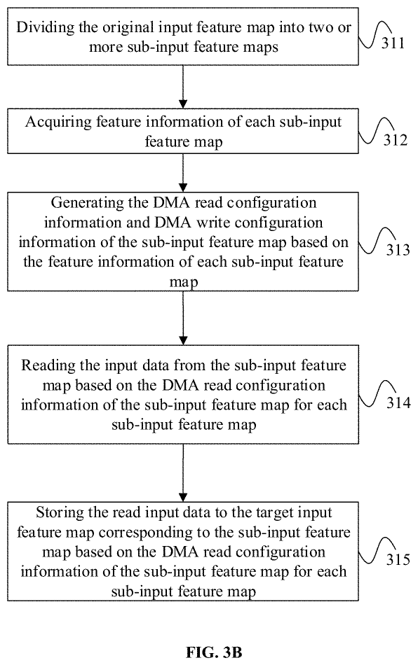

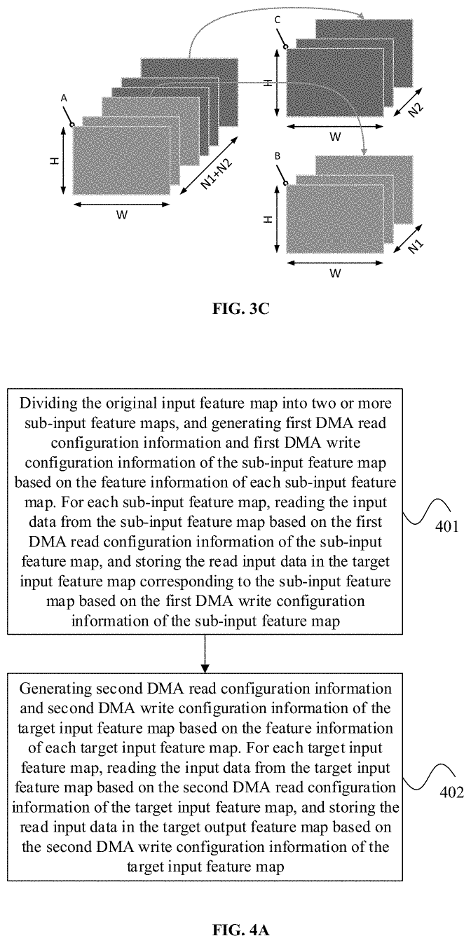

In the CNN, instead of using the CPU to implement the data movement task, the DMA controller can be used to implement the data movement task. Referring to FIG. 3, which is an example of a flowchart of the data processing method in a CNN. The method can be applied to a DMA controller, and the method will be described in detail below.

301, dividing the original input feature map into two or more sub-input feature maps.

302, acquiring feature information of each sub-input feature map and generating the DMA read configuration information and the DMA write configuration information of the sub-input feature map based on the feature information of each sub-input feature map.

303, reading input data from the sub-input feature map based on the DMA read configuration information of the sub-input feature map and storing the read input data to the target input feature map corresponding to the sub-input feature map based on the DMA write configuration information of the sub-input feature map for each sub-input feature map.

In some embodiments, different sub-input feature maps may correspond to different target input feature maps, that is, the number of sub-input feature maps may be the same as the number of the target input feature maps, and each sub-input feature map may correspond to one target input feature map. For example, if there are two sub-input feature maps, the sub-input feature map 1 may correspond to the target input feature map 1, and the sub-input feature map 2 may correspond to the target input feature map 2.

In the above embodiment, the original input feature map may be an initial feature map, and the original input feature map may be divided into two or more sub-input feature maps. The sub-input feature map may also be the initial feature map, and the DMA controller may read data from the sub-input feature map, that is, the sub-input feature map may be used as the source data. Further, the target input feature map may be a target feature map, the DMA controller may write data to the target input feature map, and each sub-input feature map may correspond to a target input feature map. As such, the DMA controller may read data from the sub-input feature map and write the data into the target input feature map corresponding to the sub-input feature map.

In some embodiments, the DMA read configuration information may be the DMA configuration information used to read data from the sub-input feature map. Therefore, the input data may be read from the sub-input feature map based on the DMA read configuration information, and the reading process may be the process of reading data from the source address (i.e., the sub-input feature map).

In some embodiments, the DMA write configuration information may be the DMA configuration information used to store input data to the target input feature map (i.e., the initially constructed target input feature map in the initial state without data being written in the sub-input feature map. The subsequent embodiments will introduce the construction process of the target input feature map.). As such, the input may be stored to the target input feature map based on the DMA write configuration information. The writing process, which is the process of writing data from the source address to the destination address (i.e., the target input feature map), can move the data from the sub-input feature map to the target input feature map, and obtain the target input feature map that meets the needs.

In the above embodiment, the DMA read configuration information and DMA write configuration information may include the X-direction count configuration (X_COUNT), X-direction stride configuration (X_STRIDE), Y-direction count configuration (Y_COUNT), and Y-direction stride configuration (Y_STRIDE). In addition, the DMA read configuration information and DMA write configuration information may further include the Z-direction count configuration (Z_COUNT), and the Z-direction stride configuration (Z_STRIDE).

Based on the technical solution described above, in some embodiments of the present disclosure, the data movement in the CNN can be realized by the DMA controller, and the data movement in the CNN does not need to be realized by the CPU, thereby reducing the burden on the CPU and moving the data more efficiently, which may accelerate the CNN operations without losing flexibility.

The above technical solution will be described in detail below in combination with a specific application scenario related to the implementation of slice. Slice is the reverse operation of concatenation. In particular, slice is an input feature map that divides a layer based on channels. For example, an input feature map (e.g., the original input feature map) with 50 channels may be divided into 5 parts at the intervals of 10, 20, 30, and 40. Each part may include 10 channels to obtain 5 input feature maps (e.g., the target input feature map). If the CPU is used to complete the task of dividing the input feature map, the burden of the CPU may be increased. As such, the task of dividing the input feature map may be completed by the DMA controller, thereby reducing the burden on the CPU. The task of dividing the input feature map will be described in detail below with reference to FIG. 3B.

311, dividing the original input feature map into two or more sub-input feature maps.

For example, assume that the width of the original input feature map may be W, the height may be H, the number of channels may be N1+N2, the original input feature map may be continuously stored in the memory, and the starting address may be A. If the original input feature map needs to be divided into two target input feature maps based on the number of channels, the original input feature map may be divided into two sub-input feature maps based on the number of channels, that is, the sub-input feature map 1 and the sub-input feature map 2. The sub-input feature map 1 may be the first part of the original input feature map, the sub-input feature map 2 may be the second part of the original input feature map, and the sub-input feature map 1 and the sub-input feature map 2 may constitute the original input feature map.

In some embodiments, the width of the sub-input feature map 1 may be W, the height may be H, the number of channels may be N1, the sub-input feature map 1 may be continuously stored in the memory, and the starting address may be A. That is, the starting address of the sub-input feature map 1 may be the same as the starting address of the original input feature map. Further, the width of the sub-input feature map 2 may be W, the height may be H, the number of channels may be N2, the sub-input feature map 2 may be continuously stored in the memory, and the starting address may be A+W*H*N1. That is, the starting address of the sub-input feature map 2 may be adjacent to the ending address of the sub-input feature map 1. The ending address of the sub-input feature map 2 may be the same as the ending address of the original input feature map, and the sub-input feature map 1 and the sub-input feature map 2 may constitute the original input feature map.

312, acquiring feature information of each sub-input feature map.

In some embodiments, the feature information may include, but is not limited to, the width W and height H of the sub-input feature map. In addition, the feature information may further include the number of channels N of the sub-input feature map, that is, the number N.

In some embodiments, for the two or more sub-input feature maps, the width W of all the sub-input feature maps may be the same, and the height H of all the sub-input feature maps may be the same. The number of channels of different sub-input feature maps may be the same or different, but the sum of the number of channels of all sub-input feature maps may be the number of channels of the original input feature map. For example, the number of channels in the sub-input feature map 1 may be N1, and the number of channels in the sub-input feature map 2 may be N2. N1 and N2 may be the same or different, and the sum of N1 and N2 may be the number of channels in the original input feature map.

For the ease of description, two sub-input feature maps will be used as an example for illustration in the following description. Assume that the width of the original input feature map may be W, the height may be H, the number of channels may be N1+N2, original input feature map may be continuously stored in the memory, and the starting address may be A. As such, the width of the sub-input feature map 1 may be W, the height may be H, the number of channels may be N1, the sub-input feature map 1 may be continuously stored in the memory, and the starting address may be A. Further, the width of the sub-input feature map 2 may be W, the height may be H, the number of channels may be N2, the sub-input feature map 2 may be continuously stored in the memory, and the starting address may be A+W*H*N1.

In addition, for the target input feature map 1 corresponding to the sub-input feature map 1, the width may be W, the height may be H, the number of channels may be N1, the target input feature map 1 may be continuously stored in the memory, and the starting address may be B. Further, the data in the sub-input feature map 1 of the original input feature map may need to be migrated to the target input feature map 1.

In addition, for the target input feature map 2 corresponding to the sub-input feature map 2, the width may be W, the height may be H, the number of channels may be N2, the target input feature map 2 may be continuously stored in the memory, and the starting address may be C. Further, the data in the sub-input feature map 2 of the original input feature map may need to be migrated to the target input feature map 2.

313, generating the DMA read configuration information and DMA write configuration information of the sub-input feature map based on the feature information of each sub-input feature map. For example, the DMA controller may generate the DMA read configuration information and DMA write configuration information of the sub-input feature map 1 based on the feature information of the sub-input feature map 1. In addition, the DMA controller may generate the DMA read configuration information and DMA write configuration information of the sub-input feature map 2 based on the feature information of the sub-input feature map 2.

In some embodiments, generating the DMA read configuration information of the sub-input feature map based on the feature information of the sub-input feature map may include using the DMA controller to generate the X-direct count configuration based on the width W of the sub-input feature map; generating the Y-direction count configuration based on the height H of the sub-input feature map; and generating the X-direction stride configuration and the Y-direction stride configuration based on a predetermined value (such as 1). In addition, the DMA controller may also generate the Z-direction count configuration based on the number of channels N; and the Z-direction step configuration based on a predetermined value (such as 1).

For example, the DMA read configuration information may include the X-direction count configuration: W; Y-direction count configuration: H; X-direction stride configuration: 1; and Y-direction stride configuration: 1. In addition, the DMA read configuration information may further include the Z-direction count configuration: N; and Z-direction stride configuration: 1.

Of course, the DMA read configuration information provided above is merely an example of the present disclosure. The present disclosure does not limit the DMA read configuration information, and it can be configured based on experience. The present disclosure uses the DMA read configuration information described above as an example.

For example, the DMA read configuration information for the sub-input feature map 1 may include the X-direction count configuration: W; Y-direction count configuration: H; X-direction stride configuration: 1; Y-direction stride configuration; Z-direction count configuration: N1; and Z-direction stride configuration: 1. The DMA read configuration information for the sub-input feature map 2 may include the X-direction count configuration: W; Y-direction count configuration: H; X-direction stride configuration: 1; Y-direction stride configuration; Z-direction count configuration: N2; and Z-direction stride configuration: 1.

In some embodiments, generating the DMA write configuration information of the sub-input feature map based on the feature information of the sub-input feature map may include using the DMA controller to generate the X-direct count configuration based on the width W of the sub-input feature map; generating the Y-direction count configuration based on the height H of the sub-input feature map; and generating the X-direction stride configuration and the Y-direction stride configuration based on a predetermined value (such as 1). In addition, the DMA controller may also generate the Z-direction count configuration based on the number of channels N; and the Z-direction step configuration based on a predetermined value (such as 1).

For example, the DMA write configuration information may include the X-direction count configuration: W; Y-direction count configuration: H; X-direction stride configuration: 1; and Y-direction stride configuration: 1. In addition, the DMA read configuration information may further include: Z-direction count configuration: N; and Z-direction stride configuration: 1.

Of course, the DMA write configuration information provided above is merely an example of the present disclosure. The present disclosure does not limit the DMA write configuration information, and it can be configured based on experience. The present disclosure uses the DMA write configuration information described above as an example.

For example, the DMA write configuration information for the sub-input feature map 1 may include the X-direction count configuration: W; Y-direction count configuration: H; X-direction stride configuration: 1; Y-direction stride configuration; Z-direction count configuration: N1; and Z-direction stride configuration: 1. The DMA write configuration information for the sub-input feature map 2 may include the X-direction count configuration: W; Y-direction count configuration: H; X-direction stride configuration: 1; Y-direction stride configuration; Z-direction count configuration: N2; and Z-direction stride configuration: 1.

314, reading the input data from the sub-input feature map based on the DMA read configuration information of the sub-input feature map for each sub-input feature map. More specifically, the DMA controller may read each input data in the sub-input feature map based on the DMA read configuration information of the sub-input feature map starting from the corresponding starting address of the sub-input feature map. In particular, the process of reading the input data from the sub-input feature map may the process of reading the input data from the original input feature map.

In some embodiments, if there are two sub-input feature maps, the starting address of the first sub-input feature map may be the starting address A of the original input feature map, and the starting address of the second sub-input feature map may be A+W*H*N, where W, H, and N may be the width, height, and number of channels of the first sub-input feature map, respectively.

For example, the DMA controller may read each input in the sub-input feature map 1 based on the DMA read configuration information of the sub-input feature map 1 starting from the starting address A of the sub-input feature map 1. Further, the DMA controller may read each input in the sub-input feature map 2 based on the DMA read configuration information of the sub-input feature map 2 starting from the starting address A+W*H*N1 of the sub-input feature map 2.

315, storing the read input data to the target input feature map corresponding to the sub-input feature map based on the DMA read configuration information of the sub-input feature map for each sub-input feature map.

In some embodiments, each sub-input feature map may correspond to a target input feature map. The DMA controller may store each read input data to the target input feature map based on the DMA write configuration information of the sub-input feature map starting from the starting address of the target input feature map corresponding to the sub-input feature map.

For example, the DMA controller may store each read input data to the target input feature map 1 based on the DMA write configuration information of the sub-input feature map 1 starting from the starting address B of the target input feature map 1 corresponding to the sub-input feature map 1. The DMA controller may store each read input data to the target input feature map 2 based on the DMA write configuration information of the sub-input feature map 2 starting from the starting address B of the target input feature map 2 corresponding to the sub-input feature map 2. In particular, the target input feature map 1 and the target input feature map 2 may be two different target input feature maps, and the starting addresses of the two may not be related.

As shown in FIG. 3C, the slice operation of dividing the original input feature map into two target input feature maps can be implemented in two steps. In the first step, the DMA controller may extract the first half of the data of the original input feature map (that is, the sub-input feature map 1) and write it to the target input feature map 1 starting from the starting address B. In the second step, the DMA controller may extract the second half of the data of the original input feature map (that is, the sub-input feature map 2) and write it to the target input feature map 2 starting from the starting address C. As such, by using the two-step moving operation, the slice operation of the original input feature map can be realized.

In some embodiments, before storing the read input data in the target input feature map corresponding to the sub-input feature map, for each sub-input feature map, the target DMA configuration information of the sub-input feature map may also be generated based on the feature information of the sub-input feature map, and the target input feature map corresponding to the sub-input feature map may be constructed based on the target DMA configuration information of the sub-input feature map. The constructed target input feature map may be a target input feature map in the initial state without data in the original input feature map being written in the target input feature map. The constructed target input feature map may be a specific feature map or a feature map including all 0s or 1s. In 315, the input data may be stored to the constructed target input feature map. After all the data is stored to the constructed target input feature map, the final target input feature map may be obtained.

In some embodiments, the feature information of the sub-input feature map may include the width W, the height H, and the number of channels N of the sub-input feature map. Further, generating the target DMA configuration information of the sub-input feature map based on the feature information of the sub-input feature map may include using the DMA controller to generate the X-direction count configuration based on the width W of the sub-input feature map, the Y-direction count configuration based on the height H of the sub-input feature map, and the Z-direction count configuration based on the number of channels N of the sub-input feature map. Subsequently, the X-direction stride configuration, the Y-direction stride configuration, and the Z-direction stride configuration may also be generated based on a predetermined value (such as 1).

For example, the target DMA configuration information may include the X-direction count configuration: W; Y-direction count configuration: H; X-direction stride configuration: 1; and Y-direction stride configuration: 1. In particular, for the target DMA configuration information corresponding to different sub-input feature maps, the Z-direction count configuration may be the same or different. For example, the Z-direction count of the sub-input feature map 1 may be configured as the number of channels N1, and the Z-direction count of the sub-input feature map 2 may be configured as the number of channels N2.

Of course, the target DMA configuration information provided above is merely an example of the present disclosure. The present disclosure does not limit the target DMA configuration information, and it can be configured based on experience. The present disclosure uses the target DMA configuration information described above as an example.

In some embodiments, constructing the target input feature map corresponding to the sub-input feature map based on the target DMA configuration information of the sub-input feature map may include using the DMA controller to construct a target input feature map of the size W*H*N based on the target DMA configuration information, where the target input feature map may be all 0s, W may be the width of the sub-input feature map, and N may be the number of channels of the sub-input feature map.

In some embodiments, constructing the target input feature map corresponding to the sub-input feature map based on the target DMA configuration information of the sub-input feature map may include reading specific pattern information from a specific storage location, and constructing the target input feature map corresponding to the specific pattern information based on the target DMA configuration information of the sub-input feature map. Further, a target input feature map of all 0s corresponding to the specific pattern information may be constructed based on the target DMA configuration information. Of course, a target input feature map of all is may also be constructed.

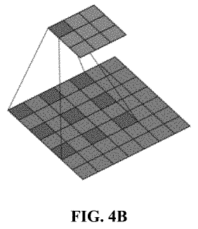

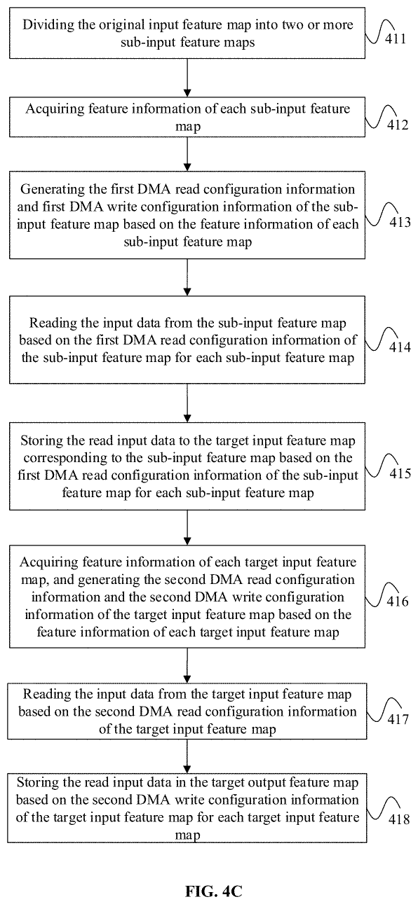

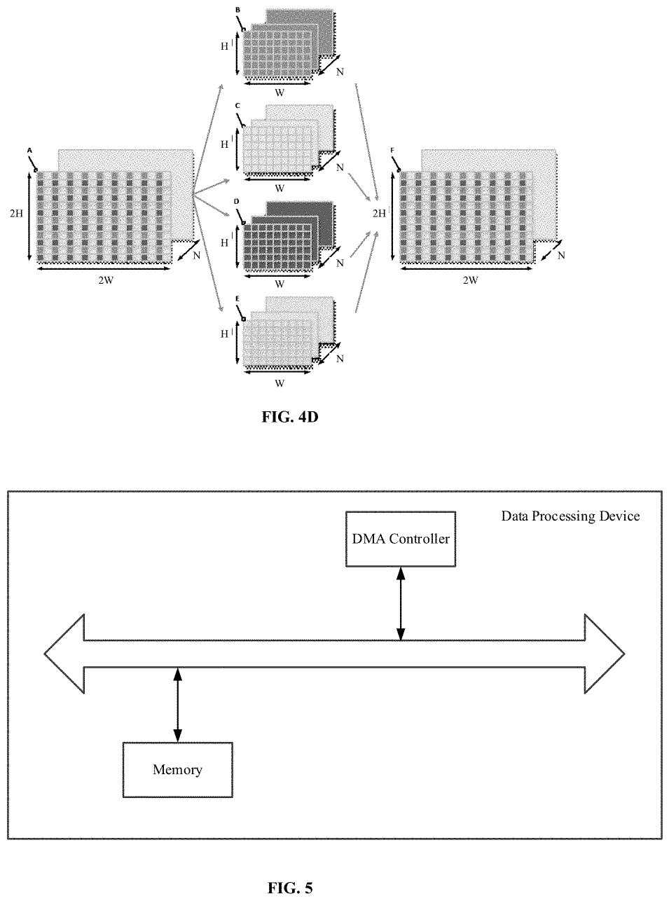

In the CNN, instead of using the CPU to implement the data movement task, the DMA controller can be used to implement the data movement task. Referring to FIG. 4A, which is an example of a flowchart of the data processing method in a CNN. The method can be applied to a DMA controller, and the method will be described in detail below.

401, dividing the original input feature map into two or more sub-input feature maps, and generating first DMA read configuration information and first DMA write configuration information of the sub-input feature map based on the feature information of each sub-input feature map. For each sub-input feature map, the input data may be read from the sub-input feature map based on the first DMA read configuration information of the sub-input feature map, and the read input data may be stored in the target input feature map corresponding to the sub-input feature map based on the first DMA write configuration information of the sub-input feature map. In some embodiments, different sub-input feature maps may correspond to different target input feature maps.

402, generating second DMA read configuration information and second DMA write configuration information of the target input feature map based on the feature information of each target input feature map. For each target input feature map, the input data may be read from the target input feature map based on the second DMA read configuration information of the target input feature map, and the read input data may be stored in the target output feature map based on the second DMA write configuration information of the target input feature map. In some embodiments, all target input feature maps may correspond to the same target output feature map.

In the embodiment described above, the original input feature map may be the initial feature map, which may be divided into two or more sub-input feature maps. The sub-input feature map may also be the initial feature map, and the DMA controller may read data from the sub-input feature map. That is, the sub-input feature map may be the source data. The target input feature map may be a target feature map, the DMA controller may write data to the target output feature map, and each sub-input feature map may correspond to a target input feature map. As such, the DMA controller may read data from the sub-input feature map and write the data into the target output feature map corresponding to the sub-input feature map.

For example, the DMA controller may divide the original input feature map into sub-input feature map 1, sub-input feature map 2, sub-input feature map 3, and sub-input feature map 4. The sub-input feature map 1 may correspond to the target input feature map 1, the sub-input feature map 2 may correspond to the target input feature map 2, the sub-input feature map 3 may correspond to the target input feature map 3, and the sub-input feature map 4 may correspond to the target input feature map 4. Subsequently, the DMA controller may write the data of the sub-input feature map 1 to the target input feature map 1, write the data of the sub-input feature map 2 to the target input feature map 2, write the data of the sub-input feature map 3 to the target input feature map 3, and write the data of the sub-input feature map 4 to the target input feature map 4.

In some embodiments, the first DMA read configuration information may be the DMA configuration information for reading data from a sub-input feature map. Therefore, input data may be read from the sub-input feature map based on the first DMA read configuration information, and the reading process may be the process of reading data from the source address (e.g., the sub-input feature map).

In some embodiments, the first DMA write configuration information may be the DMA configuration information for storing data to a target input feature map (i.e., the initially constructed target input feature map in the initial state without the data of the sub-input feature map being written. The subsequent embodiments will introduce the construction process of the target input feature map.). Therefore, input data may be stored in the target input feature map based on the first DMA write configuration information, and the writing process may be the process of writing data from the source address to the destination address (e.g., target input feature map). As such, data may be moved from the sub-input feature map to the target input feature map to obtain the target input feature map that meets the needs.

In the embodiment described above, the DMA controller may also read data from the target input feature map (for storing data of the sub-input feature map) and write data into the target output feature map, where all target input feature maps may correspond to the same target output feature map. For example, the data of the target input feature map 1, target input feature map 2, target input feature map 3, and target input feature map 4 may be written to the target output feature map.

In some embodiments, the second DMA read configuration information may be the DMA configuration information for reading data from the target input feature map. Therefore, input data may be read from the target input feature map based on the second DMA read configuration information, and the reading process may be the process of reading data from the source address.

In some embodiments, the second DMA write configuration information may be the DMA configuration information for storing data to a target output feature map (i.e., the initially constructed target output feature map in the initial state without data being written in the target input feature map. The subsequent embodiments will introduce the construction process of the target output feature map.). Therefore, input data may be stored in the target output feature map based on the second DMA write configuration information, and the writing process may be the process of writing data from the source address to the destination address. As such, data may be moved from the target input feature map to the target output feature map to obtain the target output feature map that meets the needs.

In some embodiments, the first DMA read configuration information, first DMA write configuration information, second DMA read configuration information, and second DMA write configuration information may include the X-direction count configuration (X_COUNT), X-direction stride configuration (X_STRIDE), Y-direction count configuration (Y_COUNT), Y-direction stride configuration (Y_STRIDE), Z-direction count configuration (Z_COUNT), and Z-direction stride configuration (Z_STRIDE).

Based on the technical solution described above, in some embodiments of the present disclosure, the data movement in the CNN can be realized by the DMA controller, and the data movement in the CNN does not need to be realized by the CPU, thereby reducing the burden on the CPU and moving the data more efficiently, which may accelerate the CNN operations without losing flexibility.

The above technical solution will be described in detail below in combination with a specific application scenario related to the implementation of a dilate convolution (e.g., an expanded convolution or a hole convolution). As shown in FIG. 4B, by introducing a new hyper-parameter dilate, in which a pixel of every dilate-1 pixels may be used to perform the convolution operation. On the existing pixels, some pixels may be skipped or the input may be kept unchanged, so me some 0 weights may be inserted in the convolution kernel parameters to achieve the purpose of using one convolution to see a larger space. If the CPU is used to complete the dilate convolution task of the input feature map, the burden of the CPU may be increased. As such, the dilate convolution task of the input feature map may be completed by the DMA controller, thereby reducing the burden on the CPU. The dilate convolution task of the input feature map will be described in detail below with reference to FIG. 4C.

411, dividing the original input feature map into two or more sub-input feature maps.

For example, width of the original input feature map may be 2W, the height may be 2H, the number of channels may be N, the original input feature map may be continuously stored in the memory, and the starting address may be A. If the original input feature map needs to be divided into four target input feature maps based on the width and height (take 4 as an example, and it can be other numbers such as 9 or 16 as there it is not limited in the present disclosure), the original input feature map may be divided into four sub-input feature maps, such as sub-input feature map 1, sub-input feature map 2, sub-input feature map 3, and sub-input feature map 4 based on the width and height, The sub-input feature map 1 may be the first part of the original input feature map, the sub-input feature map 2 may be the second part of the original input feature map, the sub-input feature map 3 may be the third part of the original input feature map, and the sub-input feature map 4 may be the fourth part of the original input feature map. The sub-input feature map 1, sub-input feature map 2, sub-input feature map 3, and sub-input feature map 4 may constitute the original input feature map.

412, acquiring feature information of each sub-input feature map.

In some embodiments, the feature information may include, but is not limited to, the width W and height H of the sub-input feature map. In addition, the feature information may further include the number of channels N of the sub-input feature map, that is, the number N.

In some embodiments, the width W of all the sub-input feature maps may be the same, the height H of all the sub-input feature maps may be the same, and the number of channels N of all the sub-input feature maps may be the same. For example, if the original input feature map is divided into 4 sub-input feature maps, the width of the sub-input feature maps may be ½ of the width of the original input feature map, the height of the sub-input feature maps may be ½ of the height of the original input feature map, and the number of channels of the sub-input feature maps may be the same number of channels of the original input feature map. if the original input feature map is divided into 9 sub-input feature maps, the width of the sub-input feature maps may be ⅓ of the width of the original input feature map, the height of the sub-input feature maps may be ⅓ of the height of the original input feature map, and the number of channels of the sub-input feature maps may be the same number of channels of the original input feature map, and so on.

For the ease of description, 4 sub-input feature maps will be used as an example for illustration in the following description. Assume that the width of the original input feature map may be 2W, the height may be 2H, the number of channels may be N, the original input feature map may be continuously stored in the memory, and the starting address may be A. As such, the width of the sub-input feature map 1 may be W, the height may be H, the number of channels may be N, the sub-input feature map 1 may be continuously stored in the memory, and the starting address may be A, that is, the same as the staring address of the original input feature map. The width of the sub-input feature map 2 may be W, the height may be H, the number of channels may be N, the sub-input feature map 2 may be continuously stored in the memory, and the starting address may be A+1. The width of the sub-input feature map 3 may be W, the height may be H, the number of channels may be N, the sub-input feature map 3 may be continuously stored in the memory, and the starting address may be A+2W. The width of the sub-input feature map 4 may be W, the height may be H, the number of channels may be N, the sub-input feature map 4 may be continuously stored in the memory, and the starting address may be A+2W+1.

In addition, for the target input feature map 1 corresponding to the sub-input feature map 1, the width may be W, the height may be H, the number of channels may be N, the target input feature map 1 may be continuously stored in the memory, and the starting address may be B. Further, the data in the sub-input feature map 1 of the original input feature map may need to be migrated to the target input feature map 1.

In addition, for the target input feature map 2 corresponding to the sub-input feature map 2, the width may be W, the height may be H, the number of channels may be N, the target input feature map 2 may be continuously stored in the memory, and the starting address may be C. Further, the data in the sub-input feature map 2 of the original input feature map may need to be migrated to the target input feature map 2.

In addition, for the target input feature map 3 corresponding to the sub-input feature map 3, the width may be W, the height may be H, the number of channels may be N, the target input feature map 3 may be continuously stored in the memory, and the starting address may be D. Further, the data in the sub-input feature map 3 of the original input feature map may need to be migrated to the target input feature map 3.

In addition, for the target input feature map 4 corresponding to the sub-input feature map 4, the width may be W, the height may be H, the number of channels may be N, the target input feature map 4 may be continuously stored in the memory, and the starting address may be E. Further, the data in the sub-input feature map 4 of the original input feature map may need to be migrated to the target input feature map 4.

Assuming that the dilate convolution has dilate of 2 and a stride of 1, the original input feature map may be divided into 4 sub-input feature maps of the same size. The sub-input feature map 1 and sub-input feature map 2 may be adjacent columns, sub-input feature map 3 and sub-input feature map 4 may be adjacent columns, sub-input feature map 1 and sub-input feature map 3 may be adjacent rows, and sub-input feature map 2 and sub-input feature map 4 may be adjacent rows.

413, generating the first DMA read configuration information and first DMA write configuration information of the sub-input feature map based on the feature information of each sub-input feature map. For example, the DMA controller may generate the first DMA read configuration information and first DMA write configuration information of the sub-input feature map 1 based on the feature information of the sub-input feature map 1. In addition, the DMA controller may generate the first DMA read configuration information and first DMA write configuration information of the sub-input feature map 2 based on the feature information of the sub-input feature map 2. The rest may be deduced by analogy and will not be described in detail herein.

In some embodiments, generating the first DMA read configuration information of the sub-input feature map based on the feature information of the sub-input feature map may include generating the X-direct count configuration based on the width W of the sub-input feature map; generating the Y-direction count configuration based on the height H of the sub-input feature map; generating the X-direction stride configuration based on a predetermined value, and generating the Y-direction stride configuration based on the width of the sub-input feature map. In addition, the Z-direction count configuration may be generated based on the number of channels N; and the Z-direction stride configuration may be generated based on the width W of the sub-input feature map.

For example, if the original input feature map is divided into 4 sub-input feature maps of the same size, an example of the first DMA read configuration information may include the X-direction count configuration: W; Y-direction count configuration: H; X-direction stride configuration: 2; and Y-direction stride configuration: 2W+1. In addition, the first DMA read configuration information may further include the Z-direction count configuration: N; and Z-direction stride configuration: 2W+1.

Of course, the first DMA read configuration information provided above is merely an example of the present disclosure. The present disclosure does not limit the first DMA read configuration information, and it can be configured based on experience. The present disclosure uses the first DMA read configuration information described above as an example.

In some embodiments, generating the first DMA write configuration information of the sub-input feature map based on the feature information of the sub-input feature map may include using the DMA controller to generate the X-direct count configuration based on the width W of the sub-input feature map; generating the Y-direction count configuration based on the height H of the sub-input feature map; and generating the X-direction stride configuration and the Y-direction stride configuration based on a predetermined value. In addition, the DMA controller may also generate the Z-direction count configuration based on the number of channels N; and the Z-direction step configuration based on a predetermined value.

For example, if the original input feature map is divided into 4 sub-input feature maps of the same size, an example of the first DMA write configuration information may include the X-direction count configuration: W; Y-direction count configuration: H; X-direction stride configuration: 1; and Y-direction stride configuration: 1. In addition, the first DMA write configuration information may further include: Z-direction count configuration: N; and Z-direction stride configuration: 1.

Of course, the first DMA write configuration information provided above is merely an example of the present disclosure. The present disclosure does not limit the first DMA write configuration information, and it can be configured based on experience. The present disclosure uses the first DMA write configuration information described above as an example.

414, reading the input data from the sub-input feature map based on the first DMA read configuration information of the sub-input feature map for each sub-input feature map. More specifically, the DMA controller may read each input data in the sub-input feature map based on the first DMA read configuration information of the sub-input feature map starting from the corresponding starting address of the sub-input feature map. In particular, the process of reading the input data from the sub-input feature map may the process of reading the input data from the original input feature map.

In some embodiments, if the original input feature map is divided into 4 sub-input feature maps of the same size, the starting address of the first sub-input feature map may be the starting address A of the original input feature map; the starting address of the second sub-input feature map may be A+1; the starting address of the third sub-input feature map may be A+2W; and the starting address of the fourth sub-input feature map may be A+2W+1, where 2W may be the width of the original input feature map.

For example, the DMA controller may read each input in the sub-input feature map 1 based on the first DMA read configuration information of the sub-input feature map 1 starting from the starting address A of the sub-input feature map 1. Further, the DMA controller may read each input in the sub-input feature map 2 based on the first DMA read configuration information of the sub-input feature map 2 starting from the starting address A+1 of the sub-input feature map 2. The rest may be deduced by analogy and will not be described in detail herein.

415, storing the read input data to the target input feature map corresponding to the sub-input feature map based on the first DMA read configuration information of the sub-input feature map for each sub-input feature map.

In some embodiments, each sub-input feature map may correspond to a target input feature map. The DMA controller may store each read input data to the target input feature map based on the first DMA write configuration information of the sub-input feature map starting from the starting address of the target input feature map corresponding to the sub-input feature map.

For example, each read input data may be stored to the target input feature map 1 based on the first DMA write configuration information of the sub-input feature map 1 starting from the starting address B of the target input feature map 1 corresponding to the sub-input feature map 1. Each read input data may be stored to the target input feature map 2 based on the first DMA write configuration information of the sub-input feature map 2 starting from the starting address C of the target input feature map 2 corresponding to the sub-input feature map 2. Each read input data may be stored to the target input feature map 3 based on the first DMA write configuration information of the sub-input feature map 3 starting from the starting address D of the target input feature map 3 corresponding to the sub-input feature map 3. Each read input data may be stored to the target input feature map 4 based on the first DMA write configuration information of the sub-input feature map 4 starting from the starting address E of the target input feature map 4 corresponding to the sub-input feature map 4. In particular, the target input feature map 1, target input feature map 2, target input feature map 3, and target input feature map 4 may be different target input feature maps.

In some embodiments, before storing the read input data in the target input feature map corresponding to the sub-input feature map, for each sub-input feature map, the first target DMA configuration information of the sub-input feature map may also be generated based on the feature information of the sub-input feature map, and the target input feature map corresponding to the sub-input feature map may be constructed based on the first target DMA configuration information of the sub-input feature map. The constructed target input feature map may be a target input feature map in the initial state without data in the original input feature map being written in the target input feature map. The constructed target input feature map may be a specific feature map or a feature map including all 0s or 1s. In 415, the input data may be stored to the constructed target input feature map. After all the data is stored to the constructed target input feature map, the final target input feature map may be obtained.

In some embodiments, the feature information of the sub-input feature map may include the width W, the height H, and the number of channels N of the sub-input feature map. Further, generating the first target DMA configuration information of the sub-input feature map based on the feature information of the sub-input feature map may include using the DMA controller to generate the X-direction count configuration based on the width W of the sub-input feature map, the Y-direction count configuration based on the height H of the sub-input feature map, and the Z-direction count configuration based on the number of channels N of the sub-input feature map. Subsequently, the X-direction stride configuration, the Y-direction stride configuration, and the Z-direction stride configuration may also be generated based on a predetermined value (such as 1).

For example, the first target DMA configuration information may include, but is not limited to, the X-direction count configuration: W; Y-direction count configuration: H; Z-direction count configuration: N; X-direction stride configuration: 1; Y-direction stride configuration: 1; and Z-direction stride configuration: 1.

Of course, the first target DMA configuration information provided above is merely an example of the present disclosure. The present disclosure does not limit the first target DMA configuration information, and it can be configured based on experience. The present disclosure uses the first target DMA configuration information described above as an example.

In some embodiments, constructing the target input feature map corresponding to the sub-input feature map based on the target DMA configuration information of the sub-input feature map may include using the DMA controller to construct a target input feature map of the size W*H*N based on the target DMA configuration information, where the target input feature map may be all 0s, W may be the width of the sub-input feature map, and N may be the number of channels of the sub-input feature map.

In some embodiments, constructing the target input feature map corresponding to the sub-input feature map based on the first target DMA configuration information of the sub-input feature map may include constructing the target input feature map of the size W*H*N based on the first target DMA configuration information. In particular, the target input feature map may be all 0s, W may be the width of the sub-input feature map, H may be the height of the sub-input feature map, and N may be the number of channels of the sub-input feature map.

In some embodiments, constructing the target input feature map corresponding to the sub-input feature map based on the first target DMA configuration information of the sub-input feature map may include reading specific pattern information from a specific storage location, and constructing the target input feature map corresponding to the specific pattern information based on the first target DMA configuration information of the sub-input feature map. Further, a target input feature map of all 0s or a target input feature map of all 1s may be constructed based on the first target DMA configuration information.

416, acquiring feature information of each target input feature map, and generating the second DMA read configuration information and the second DMA write configuration information of the target input feature map based on the feature information of each target input feature map. In some embodiments, the feature information may include, but is not limited to, the width W and the height H of the target input feature map. In addition, the feature information may further include the number of channels N of the target input feature map.

In some embodiments, generating the second DMA read configuration information of the target input feature map based on the feature information of the target input feature map may include using the DMA controller to generate the X-direction count configuration based on the width W of the target input feature map; the Y-direction count configuration based on the height H of the target input feature map; and generating the X-direction stride configuration and the Y-direction stride configuration based on a predetermined value. In addition, the DMA controller may also generate the Z-direction count configuration based on the number of channels N, and the Z-direction stride configuration based on the a predetermined value.

For example, the second DMA read configuration information may include the X-direction count configuration: W; Y-direction count configuration: H; X-direction stride configuration: 1; Y-direction stride configuration: 1. In addition, the second DMA read configuration information may further include the Z-direction count configuration: N and the Z-direction stride configuration: 1.

Of course, the second DMA read configuration information provided above is merely an example of the present disclosure. The present disclosure does not limit the second DMA read configuration information, and it can be configured based on experience. The present disclosure uses the second DMA read configuration information described above as an example.

In some embodiments, generating the second DMA write configuration information of the target input feature map based on the feature information of the target input feature map may include generating the X-direction count configuration based on the width W of the sub-input feature map; the Y-direction count configuration based on the height H of the sub-input feature map; generating the X-direction stride configuration based on a predetermined value; and generating the Y-direction stride configuration based on the width W of the sub-input feature map. In addition, the Z-direction count configuration may be generated based on the number of channels N, and the Z-direction stride configuration may be generated based of the width W of the sub-input feature map.

For example, if the original input feature map is divided into 4 sub-input feature maps of the same size, an example of the second DMA write configuration information may include the X-direction count configuration: W; Y-direction count configuration: H; X-direction stride configuration: 2; and Y-direction stride configuration: 2W+1. In addition, the second DMA write configuration information may further include: Z-direction count configuration: N; and Z-direction stride configuration: 2W+1.

Of course, the second DMA write configuration information provided above is merely an example of the present disclosure. The present disclosure does not limit the second DMA write configuration information, and it can be configured based on experience. The present disclosure uses the second DMA write configuration information described above as an example.

417, reading the input data from the target input feature map based on the second DMA read configuration information of the target input feature map. In some embodiments, the DMA controller may read each input data in the target input feature map based on the second DMA read configuration information of the target input feature map starting from the corresponding starting address of the target input feature map.

For example, each data in the target input feature map 1 may be read based on the second DMA read configuration information of the target input feature map 1 starting from the starting address B of the target input feature map 1. Each data in the target input feature map 2 may be read based on the second DMA read configuration information of the target input feature map 2 starting from the starting address C of the target input feature map 2. Each data in the target input feature map 3 may be read based on the second DMA read configuration information of the target input feature map 3 starting from the starting address D of the target input feature map 3. Each data in the target input feature map 4 may be read based on the second DMA read configuration information of the target input feature map 4 starting from the starting address E of the target input feature map 4.

418, storing the read input data in the target output feature map based on the second DMA write configuration information of the target input feature map for each target input feature map. In some embodiments, each read input data may be stored in the target output feature map based on the second DMA write configuration information of the target input feature map starting from the starting address of the input data in the target output feature map.

In some embodiments, the input data of different target input feature maps may have different starting addresses at the target output feature map. For example, if the original input feature map is divided into 4 sub-input feature maps of the same size, the starting address of the input data of the first target input feature map (i.e., the target input feature map corresponding to the first sub-input feature map) at the target output feature map may be the starting address F of the target output feature map. The starting address of the input data of the second target input feature map at the target output feature map may be F+1. The starting address of the input data of the third target input feature map at the target output feature map may be F+2W. The starting address of the input data of the fourth target input feature map at the target output feature map may be F+2W+1.

In some embodiments, the width of the final target output feature map (i.e., the output feature map) may be 2W, the height may be 2H, the number of channels may be N, the target output feature map may be continuously stored in the memory, and the starting address may be F.

For example, each read input data may be stored in the target output feature map based on the second DMA write configuration information of the target input feature map 1 starting from the starting address F of the target output feature map. Further, each read input data may be stored in the target output feature map based on the second DMA write configuration information of the target input feature map 2 starting from the starting address F+1 of the target output feature map, and so on.

As shown in FIG. 4D, the dilate convolution operation for the original input feature map may be realized in 8 steps. In the first step, the DMA controller may fetch the data of the sub-input feature map 1 from the starting address A, and write the data to the target input feature map 1 starting from starting address B. In the second step, the DMA controller may fetch the data of the sub-input feature map 2 from the starting address A+1, and write the data to the target input feature map 2 starting from starting address C. In the third step, the DMA controller may fetch the data of the sub-input feature map 3 from the starting address A+2W, and write the data to the target input feature map 2 starting from starting address D. In the fourth step, the DMA controller may fetch the data of the sub-input feature map 4 from the starting address A+2W+1, and write the data to the target input feature map 4 starting from starting address E. In the fifth step, the DMA controller may fetch the data of the target input feature map 1 starting from the starting address B, and write the data to the target output feature map starting from the starting address F. In the sixth step, the DMA controller may fetch the data of the target input feature map 2 starting from the starting address C, and write the data to the target output feature map starting from the starting address F+1. In the seventh step, the DMA controller may fetch the data of the target input feature map 3 starting from the starting address D, and write the data to the target output feature map starting from the starting address F+2W. In the eighth step, the DMA controller may fetch the data of the target input feature map 4 starting from the starting address E, and write the data to the target output feature map starting from the starting address F+2W+1. As such, the dilate convolution operation of the original input feature map may be realized through the eight-step moving operation. Further, the convolutional device may only need to perform the standard convolution operation of 4 target input feature maps of the size W*H*N without needing to pay attend to the impact of dilate and stride. As such, the burden of the CPU may be greatly reduce and the calculation process of the dilate convolution may be simplified.

In some embodiments, before storing the read input data in the target output feature map, the second target DMA configuration information may be generated based on the original input feature map, and the target output feature map may be constructed based on the second target DMA configuration information. The constructed target output feature map may be a target output feature map in the initial state without data in the original input feature map being written in the target output feature map. The constructed target output feature map may be a specific feature map or a feature map including all 0s or 1s. In 418, the input data may be stored to the constructed target output feature map. After all the data is stored to the constructed target output feature map, the final target output feature map may be obtained.

In some embodiments, generating the second target DMA configuration information based on the feature information of the original input feature map may include generating the X-direction count configuration based on the width of the original input feature map; generating the Y-direction count configuration based on the height of the original input feature map; generating the Z-direction count configuration based on the number of channels of the original input feature map; and generating the X-direction stride configuration, the Y-direction stride configuration, and the Z-direction stride configuration based on a predetermined value.

For example, the second target DMA configuration information may include, but is not limited to, the X-direction count configuration: 2W; Y-direction count configuration: 2H; Z-direction count configuration: N; X-direction stride configuration: 1; Y-direction stride configuration: 1; and Z-direction stride configuration: 1. In particular, 2W, 2H, and N may be the width, height, and number of channels of the original input feature map, respectively.

Of course, the second target DMA configuration information provided above is merely an example of the present disclosure. The present disclosure does not limit the second target DMA configuration information, and it can be configured based on experience. The present disclosure uses the second target DMA configuration information described above as an example.

In some embodiments, constructing the target output feature map based on the second target DMA configuration information may include using the DMA controller to construct a target output feature map of the size 2W*2H*N based on the second target DMA configuration information, where 2W, 2H, and N may be width, height, and number of channels of the original input feature map, respectively.

In some embodiments, constructing the target output feature map based on the second target DMA configuration information may include reading specific pattern information from a specific storage location, and constructing the target output feature map corresponding to the specific pattern information based on the second target DMA configuration information. Further, constructing the target output feature map corresponding to the specific pattern information based on the second target DMA configuration information may include constructing a target output feature map of all 0s or a target output feature map of all 1s based on the second target DMA configuration information.

In practical applications, many image algorithms involve the calculation of fixed matrices, such as Gaussian matrix in Gaussian filtering, Laplacian matrix and Sobel matrix in edge detection, trigonometric function matrix in fast Fourier transformation or Huff transformation, Toeplitz matrix, random matrix, and all 0/1 matrix in accelerated matrix multiplication, etc. If the above matrix is generated by the CPU, the burden of the CPU may be increased. As such, the DMA controller may be used to generate the above matrix, thereby reducing the burden of the CPU.

In the above embodiment, the process of using the DMA controller to construct the target output feature map based on the target DMA configuration information, construct the target input feature map corresponding to the sub-input feature map based on the target DMA configuration information of the sub-input feature map, construct the target input feature map corresponding to the sub-input feature map based on the first target DMA configuration information of the sub-input feature map, and construct the target output feature map based on the second target DMA configuration information may be in fact, the process of constructing the matrix using the DMA controller, instead of the CPU.

Based on the actual needs, if the target input feature map/target output feature map is a Gaussian matrix, the DMA controller may construct a Gaussian matrix; if the target input feature map/target output feature map is a trigonometric function matrix, the DMA controller may construct a trigonometric function matrix; if the target input feature map/target output feature map is a matrix of all 0s, the DMA controller may construct a matrix of all 0s; and if the target input feature map/target output feature map is a matrix of all 1s, the DMA controller may construct a matrix of all 1s, and so on, which is not limited in the present disclosure. The present disclosure uses the DMA controller to construct a matrix of all 0s as an example.

In order to implement the process described above, specific pattern information may be stored in a specified storage location, where the specific pattern information may represent the matrix type. For example, if the specific pattern information is a first identifier, it may indicate that the matrix type is an all 0 matrix (for various types of padding and interpolation); if the specific pattern information is a second identified, it may indicate that the matrix type is an all 1 matrix (for various types of padding); if the specific pattern information is a third identifier, it may indicate the matrix type is a Gaussian matrix (for 2D/3D Gaussian filtering); if the specific pattern information is a fourth identifier, it may indicate the matrix type is a Laplacian matrix (for edge detection); if the specific pattern information is a fifth identifier, it may indicate the matrix type is a Sobel matrix (for edge detection); if the specific pattern information is a sixth identifier, it may indicate the matrix type is a trigonometric function matrix (for fast Fourier transformation or Huff transformation); if the specific pattern information is a seventh identifier, it may indicate the matrix type is a Toeplitz matrix (for matrix multiplication acceleration); and if the specific pattern information is an eighth identifier, it may indicate the matrix type is a random matrix (for training weight initialization). The matrix type is not limited in the present disclosure.

As such, the DMA controller may read specific pattern information from a specified storage location and construct the target input feature map/target output feature map corresponding to the specific pattern information. For example, when the specific pattern information is the first identifier, a target input feature map/target output feature map of all 0s may be constructed.

In some embodiments, some special addresses (such as 0xFFFF_FFFF, 0x8765_4321, 0x5A5A_5A5A, etc.) may be used as the specific storage locations. Alternatively, certain field of the control flow graph (CFG) register may be used as the specified storage location, and the specific pattern information may be stored in the specified storage location, thereby specifying the matrix type. As such, the DMA controller may read specific pattern information from the specified storage location and acquire the matrix type, and construct the target input feature map/target output feature map corresponding to the matrix type.

In some embodiments, when the DMA controller constructs the matrix, the data in the matrix may be generated by the DMA controller itself (such as generating data of all 0s), and there may be no need to read data from other locations. As such, there may be no need to set the DMA configuration information for the reading processing, and only the writing process for the DMA configuration information may need to be set.

In some embodiments, 7 registers may be set for the writing process and these 7 registers may store the starting address (DST_STRT_ADDR), X-direction count configuration (X_COUNT), X-direction stride configuration (X_STRIDE), Y-direction count configuration (Y_COUNT), Y-direction stride configuration (Y_STRIDE), Z-direction count configuration (Z_COUNT), and Z-direction stride configuration (Z_STRIDE), respectively.

Based on the technical solutions of the above mention, an embodiment of the present disclosure further provides a DMA controller. The DMA controller may be configured to acquire feature information of two or more original output feature maps and generate the DMA read configuration information and DMA write configuration information of the original output feature maps based on the feature information of each original output feature map; and read input data from the original output feature map based on the DMA read configuration information of the original output feature map, and store the read input data to the target output feature map based on the DMA write configuration information of the original output feature map for each original output feature map.

In some embodiments, the feature information may include the width W, the height H, and the number of channels N of the original output feature map.

In some embodiments, the DMA controller may be configured to generate the DMA read configuration information of the original output feature map based on the feature information of the original output feature map. More specifically, the DMA controller may generate the X-direction count configuration based on the width W of the original output feature map; generate the Y-direction count configuration based on the height H of the original output feature map; generate the X-direction stride configuration and the Y-direction stride configuration based on a predetermined value; generate the Z-direction count configuration based on the number of channels N; and generate the Z-direction stride configuration based on a predetermined value.

In some embodiments, the feature information may include the width W, the height H, and the number of channels N of the original output feature map.

In some embodiments, the DMA controller may be configured to generate the DMA write configuration information of the original output feature map based on the feature information of the original output feature map. More specifically, the DMA controller may generate the X-direction count configuration based on the width W of the original output feature map; generate the Y-direction count configuration based on the height H of the original output feature map; generate the X-direction stride configuration and the Y-direction stride configuration based on a predetermined value; generate the Z-direction count configuration based on the number of channels N; and generate the Z-direction stride configuration based on a predetermined value.

In some embodiments, the DMA controller may be configured to read input data from the original output feature map based on the DMA read configuration information of the original output feature map. More specifically, the DMA controller may read each input data in the original output feature map based on the DMA read configuration information of the original output feature map starting from the starting address corresponding to the original output feature map. In addition, the DMA controller may be configured to store the read input data to the target output feature map based on the DMA write configuration information of the original output feature map. More specifically, the DMA controller may store each read input data to the target output feature map based on the DMA write configuration information of the original output feature map starting from the starting address of the input data in the target output feature map.

In some embodiments, the DMA controller may be further configured to generate the target DMA configuration information based on the feature information of all original output feature maps before storing the read input data to the target output feature map. Further, the DMA controller may be configured to construct the target output feature map based on the target DMA configuration information.

In some embodiments, the feature information may include the width W, the height H, and the number of channels N of the original output feature map.

In some embodiments, the DMA controller may be configured to generate the target DMA configuration information based on the feature information of all original output feature maps. More specifically, the DMA controller may generate the X-direction count configuration based on the width W of all original output feature maps; generate the Y-direction count configuration based on the height H of all original output feature maps; generate the Z-direction count configuration based on the number of channels N of all original output feature maps; and generate the X-direction stride configuration, the Y-direction stride configuration, and the Z-direction stride configuration based on a predetermined value.

In some embodiments, the DMA controller may be configured to construct the target output feature map based on the target DMA configuration information. More specifically, the DMA controller may read specific pattern information from a specified storage location and construct the target output feature map corresponding to the specific pattern information based on the target DMA configuration information.

An embodiment of the present disclosure further provides a DMA controller. The DMA controller may be configured to divide the original input feature map into two or more sub-input feature maps; acquire feature information of each sub-input feature map and generate the DMA read configuration information and the DMA write configuration information of the sub-input feature map based on the feature information of each sub-input feature map; and read input data from the sub-input feature map based on the DMA read configuration information of the sub-input feature map and store the read input data to the target input feature map corresponding to the sub-input feature map based on the DMA write configuration information of the sub-input feature map for each sub-input feature map. In particular, different sub-input feature maps may correspond to different target input feature maps.

In some embodiments, the feature information may include the width W, the height H, and the number of channels N of the sub-input feature map.

In some embodiments, the DMA controller may be configured to generate the DMA read configuration information of sub-input feature map based on the feature information of the sub-input feature map. More specifically, the DMA controller may generate the X-direction count configuration based on the width W of the sub-input feature map, generate the Y-direction count configuration based on the height H of the sub-input feature map, generate the X-direction stride configuration and the Y-direction stride configuration based on a predetermined value; generate the Z-direction count configuration based on the number of channels N; and generate the Z-direction stride configuration based on a predetermined value.

In some embodiments, the feature information may include the width W, the height H, and the number of channels N of the sub-input feature map.

In some embodiments, the DMA controller may be configured to generate the DMA write configuration information of the sub-input feature map based on the feature information of the sub-input feature map. More specifically, the DMA controller may generate the X-direction count configuration based on the width W of the sub-input feature map; generate the Y-direction count configuration based on the height H of the sub-input feature map; generate the X-direction stride configuration and the Y-direction stride configuration based on a predetermined value; generate the Z-direction count configuration based on the number of channels N; and generate the Z-direction stride configuration based on a predetermined value.

In some embodiments, the DMA controller may be configured to read input data from the sub-input feature map based on the DMA read configuration information of sub-input feature map. More specifically, the DMA controller may read each input data in the sub-input feature map based on the DMA read configuration information of the sub-input feature map starting from the starting address corresponding to the sub-input feature map. In addition, the DMA controller may be configured to store the read input data to the target input feature map corresponding to the sub-input feature map based on the DMA write configuration information of the sub-input feature map. More specifically, the DMA controller may store each read input data to the target input feature map based on the DMA write configuration information of the sub-input feature map starting from the starting address of the input data in the target input feature map corresponding to the sub-input feature map.

In some embodiments, the DMA controller may be further configured to generate the target DMA configuration information of the sub-input feature map based on the feature information of the sub-input feature map for each sub-input feature map before storing the read input data in the target input feature map corresponding to the sub-input feature map. Further, the DMA controller may be configured to construct the target input feature map corresponding to the sub-input feature map based on the target DMA configuration information of the sub-input feature map.

In some embodiments, the feature information may include the width W, the height H, and the number of channels N of the sub-input feature map.

In some embodiments, the DMA controller may be configured to generate the target DMA configuration information of the sub-input feature map based on the feature information of the sub-input feature map. More specifically, the DMA controller may generate the X-direction count configuration based on the width W of the sub-input feature map; generate the Y-direction count configuration based on the height H of sub-input feature map; generate the Z-direction count configuration based on the number of channels N of the sub-input feature map; and generate the X-direction stride configuration, the Y-direction stride configuration, and the Z-direction stride configuration based on a predetermined value.

In some embodiments, the DMA controller may be configured to construct the target input feature map corresponding to the sub-input feature map based on the target DMA configuration information of the sub-input feature map. More specifically, the DMA controller may read specific pattern information from a specified storage location and construct the target input feature map corresponding to the specific pattern information based on the target DMA configuration information of the sub-input feature map.

An embodiment of the present disclosure further provides a DMA controller. The DMA controller may be configured to divide the original input feature map into two or more sub-input feature maps and generate first DMA read configuration information and first DMA write configuration information of the sub-input feature map based on the feature information of each sub-input feature map. The input data may be read from the sub-input feature map based on the first DMA read configuration information of the sub-input feature map for each sub-input feature map. Further, the read input data may be stored in the target input feature map corresponding to the sub-input feature map based on the first DMA write configuration information of the sub-input feature map. In particular, different sub-input feature maps may correspond to different target input feature maps. The DMA controller may be configured to generate second DMA read configuration information and second DMA write configuration information of the target input feature map based on the feature information of each target input feature map. The input data may be read from the target input feature map based on the second DMA read configuration information of the target input feature map for each target input feature map. Further, the read input data may be stored in the target output feature map based on the second DMA write configuration information of the target input feature map.

In some embodiments, the feature information of the sub-input feature map may include the width W, the height H, and the number of channels N of the sub-input feature map. Further, the DMA controller may be configured to generate the first DMA read configuration information of the sub-input feature map based on the feature information of the sub-input feature map. More specifically, the DMA controller may be configured to generate the X-direction count configuration based on the width W of the sub-input feature map; generate the Y-direction count configuration based on the height H of the sub-input feature map; generate the X-direction stride configuration based on a predetermined value; generate the Y-direction stride configuration based on the width of the sub-input feature map; generate the Z-direction count configuration based on the number of channels N; and generate the Z-direction stride configuration based on the sub-input feature map.

In some embodiments, the feature information of the sub-input feature map may include the width W, the height H, and the number of channels N of the sub-input feature map. Further, the DMA controller may be configured to generate the first DMA write configuration information of the sub-input feature map based on the feature information of the sub-input feature map. More specifically, the DMA controller may be configured to generate the X-direction count configuration based on the width W of the sub-input feature map; generate the Y-direction count configuration based on the height H of the sub-input feature map; generate the X-direction stride configuration and the Y-direction stride configuration based on a predetermined value; generate the Z-direction count configuration based on the number of channels N; and generate the Z-direction stride configuration based on a predetermined value.

In some embodiments, the DMA controller may be configured to read input data from the sub-input feature map based on the first DMA read configuration information of the sub-input feature map. More specifically, the DMA controller may be configured to read each input data in the sub-input feature map based on the first DMA read configuration information of the sub-input feature map starting from the starting address corresponding to the sub-input feature map. Further, the DMA controller may be configured to store the read input data in the target input feature map corresponding to the sub-input feature map based on the first DMA write configuration information of the sub-input feature map. More specifically, the DMA controller may be configured to store each read input data to the target input feature map based on the first DMA write configuration information of the sub-input feature map starting from the starting address of the target input feature map corresponding to the sub-input feature map.

In some embodiments, before the DMA controller stores the read input data in the target input feature map corresponding to the sub-input feature map, the DMA controller may be further configured to generate the first target DMA configuration information of the sub-input feature map based on the feature information of the sub-input feature map for each sub-input feature map. Further, the DMA controller may be configured to construct the target input feature map corresponding to the sub-input feature map based on the first target DMA configuration information of the sub-input feature map.

In some embodiments, the feature information of the sub-input feature map may include the width W, the height H, and the number of channels N of the sub-input feature map. Further, the DMA controller may be configured to generate the first target DMA configuration information of the sub-input feature map based on the feature information of the sub-input feature map. More specifically, the DMA controller may be configured to generate the X-direction count configuration based on the width W of the sub-input feature map; generate the Y-direction count configuration based on the height H of the sub-input feature map; generate the Z-direction count configuration based on the number of channels N of the sub-input feature map; and generate the X-direction stride configuration, the Y-direction stride configuration, and the Z-direction stride configuration based on a predetermined value.

In some embodiments, the DMA controller may be configured to construct the target input feature map corresponding to the sub-input feature map based on the first target DMA configuration information of the sub-input feature map. More specifically, the DMA controller may be configured to read specific pattern information from a specified storage location and construct the target input feature map corresponding to the specific pattern information based on the first target DMA configuration information of the sub-input feature map.

In some embodiments, the feature information of the target input feature map may include the width W, the height H, and the number of channels N of the target input feature map. Further, the DMA controller may be configured to generate the second DMA read configuration information of the target input feature map based on the feature information of the target input feature map. More specifically, the DMA controller may be configured to generate the X-direction count configuration based on the width W of the target input feature map; generate the Y-direction count configuration based on the height H of the target input feature map; generate the X-direction stride configuration and Y-direction stride configuration based on a predetermined value; generate the Z-direction count configuration based on the number of channels N; and generate the Z-direction stride configuration based on a predetermined value.

In some embodiments, the feature information of the target input feature map may include the width W, the height H, and the number of channels N of the target input feature map. Further, the DMA controller may be configured to generate the second DMA write configuration information of the target input feature map based on the feature information of the target input feature map. More specifically, the DMA controller may be configured to generate the X-direction count configuration based on the width W of the sub-input feature map; generate the Y-direction count configuration based on the height H of the sub-input feature map; generate the X-direction stride configuration based on a predetermined value; generate the Y-direction stride configuration based on the width W of the sub-input feature map; generate the Z-direction count configuration based on the number of channels N; and generate the Z-direction stride configuration based on the width W of the sub-input feature map.

In some embodiments, the DMA controller may be configured to read input data from the target input feature map based on the second DMA read configuration information of the target input feature map. More specifically, the DMA controller may be configured to read each input data in the target input feature map based on the second DMA read configuration information of the target input feature map starting from the starting address corresponding to the target input feature map. In addition, the DMA controller may be configured to store the read input data to the target output feature map based on the second DMA write configuration information of the target input feature map. More specifically, the DMA controller may be configured to store each read input data in the target output feature map based on the second DMA write configuration information of the target input feature map starting from the starting address of the input data in the target output feature map.

In some embodiments, before storing the read input data in the target output feature map, the DMA controller may be further configured to generate the second target DMA configuration information based on the feature information of the original input feature map, and construct the target output feature map based on the second target DMA configuration information.

In some embodiments, the DMA controller may be configured to generate the second target DMA configuration information based on the feature information of the original input feature map. More specifically, the DMA controller may be configured to generate the X-direction count configuration based on the width of the original input feature map; generate the Y-direction count configuration based on the height of the original input feature map; generate the Z-direction count configuration based on the number of channels of the original input feature map; and generate the X-direction stride configuration, Y-direction stride configuration, and Z-direction stride configuration based on a predetermined value.

In some embodiments, the DMA controller may be configured to construct the target output feature map based on the second target DMA configuration information. More specifically, the DMA controller may be configured to read specific pattern information from a specified storage location and construct the target output feature map corresponding to the specific pattern information based on the second target DMA configuration information.

Based on the technical solutions of the above mention, an embodiment of the present disclosure further provides a data processing device. As shown in FIG. 5, the data processing device includes a memory and a DMA controller. The memory may be configured to store program code, and the DMA controller may be configured to call the program code. When the program code is executed, the data processing method described in the previous embodiments may be implemented.

Based on the technical solutions of the above mention, an embodiment of the present disclosure further provides a computer-readable storage medium. A plurality of computer instructions may be stored on the computer-readable storage medium. When the computer instruction are executed, the data processing method described in the previous embodiments may be implemented.

The system, the apparatus, the module, or the unit described in the foregoing implementations can be specifically implemented by a computer chip or an entity, or can be implemented by a product with a specific function. A typical implementation device is a computer. Specifically, the computer can be, for example, a personal computer, a laptop computer, an in-vehicle man-machine interaction device, a cellular phone, a camera phone, a personal digital assistant, a media player, a navigation device, an email device, a game console, a tablet computer, a wearable device, or a combination of any of these devices.

For the sake of convenient description, the above system is functionally divided into various units which are separately described. When implementing the disclosed system, the functions of various units may be implemented in one or more instances of software and/or hardware.

Those skilled in the art shall appreciate that the embodiments of the present disclosure can be embodied as a method, a system or a computer program product. Therefore the present disclosure can be embodied in the form of an all-hardware embodiment, an all-software embodiment or an embodiment of software and hardware in combination. Furthermore, the invention can be embodied in the form of a computer program product embodied in one or more computer useable storage mediums (including but not limited to a disk memory, a CD-ROM, an optical memory, etc.) in which computer useable program codes are contained.

The present disclosure has been described with reference to flowcharts and/or block diagrams of the method, the device (system) and the computer program product according to the embodiments of the present disclosure. It shall be appreciated that respective workflows and/or blocks in the flowcharts and/or the block diagrams and combinations of the workflows and/or the blocks in the flowcharts and/or the block diagrams can be embodied in computer program instructions. These computer program instructions can be loaded onto a general-purpose computer, a specific-purpose computer, an embedded processor or a processor of another programmable data processing device to produce a machine so that the instructions executed on the computer or the processor of the other programmable data processing device create means for performing the functions specified in the workflow(s) of the flowcharts and/or the block(s) of the block diagrams.

These computer program instructions can also be stored into a computer readable memory capable of directing the computer or the other programmable data processing device to operate in a specific manner so that the instructions stored in the computer readable memory create manufactures including instruction means which perform the functions specified in the workflow(s) of the flowcharts and/or the block(s) of the block diagrams.

These computer program instructions can also be loaded onto the computer or the other programmable data processing device so that a series of operational steps are performed on the computer or the other programmable data processing device to create a computer implemented process so that the instructions executed on the computer or the other programmable device provide steps for performing the functions specified in the workflow(s) of the flowcharts and/or the block(s) of the block diagrams.

The above are the embodiments of the present disclosure and are not intended to limit the present disclosure. It will be apparent to those skilled in the art that various modifications and changes can be made in the present disclosure. Any modifications, equivalents, and improvements made within the spirit and scope of the present disclosure are intended to be included within the scope of the appended claims.

What is claimed is:

1. A data processing method for a direct memory access (DMA) controller, comprising:
acquiring feature information of two or more original output feature maps, and generating DMA read configuration information and DMA write configuration information of the original output feature maps based on the feature information of each original output feature map; and
reading input data from the original output feature map based on the DMA read configuration information of the original output feature map, and storing the read input data to a target output feature map based on the DMA write configuration information of the original output feature map for each original output feature map.

2. The method of claim 1, wherein the feature information includes a width W and a height H of the original output feature map, and
generating the DMA read configuration information of the original output feature map based on the feature information of the original output feature map includes generating an X-direction count configuration based on the width W of the original output feature map; a Y-direction count configuration based on the height H of the original output feature map; and a X-direction stride configuration and a Y-direction stride configuration based on a value.

3. The method of claim 2, wherein the feature information further includes a number of channels N of the original output feature map, and
generating the DMA read configuration information of the original output feature map based on the feature information of the original output feature map includes generating a Z-direction count configuration based on the number of channels N, and a Z-direction stride configuration based on the value.

4. The method of claim 1, wherein the feature information includes the width W and height H of the original output feature map, and
generating the DMA write configuration information of the original output feature map based on the feature information of the original output feature map includes generating the X-direction count configuration based on the width W of the original output feature map; the Y-direction count configuration based on the height H of the original output feature map; and the X-direction stride configuration and the Y-direction stride configuration based on a value.

5. The method of claim 4, wherein the feature information further includes the number of channels N of the original output feature map, and
generating the DMA write configuration information of the original output feature map based on the feature information of the original output feature map further includes generating the Z-direction count configuration based on the number of channels N, and the Z-direction stride configuration based on the value.

6. The method of claim 1, further includes:
reading each input data in the original output feature map based on the DMA read configuration information of the original output feature map starting from a starting address corresponding to the original output feature map.

7. The method of claim 1, further includes:
storing each read input data to the target output feature map based on the DMA write configuration information of the original output feature map starting from a starting address of the input data in the target output feature map.

8. The method of claim 7, wherein in response to the two or more original output feature maps being two original output feature maps, the starting address of the input data of a first original output feature map in the target output feature map is a starting address C of the target output feature map, and the starting address of the input data of a second original output feature map in the starting address of the target output feature map is C+W*H*N, where W, H, and N are the width, height, and number of channels of the first original output feature map, respectively.

9. The method of claim 1, further includes:
generating target DMA configuration information based on the feature information of all original output feature maps and constructing the target output feature map based on the target DMA configuration information before storing the read input data to the target output feature map.

10. The method of claim 9, wherein the feature information includes the width W, height H, and number of channels N of the original output feature map, and
generating the target DMA configuration information based on the feature information of all original output feature maps includes generating the X-direction count configuration based on the width W of all original output feature maps; the Y-direction count configuration based on the height H of all original output feature maps; the Z-direction count configuration based on the number of channels N of all original output feature maps; and the X-direction stride configuration, Y-direction stride configuration, and Z-direction stride configuration based on a value.

11. The method of claim 9, wherein constructing the target output feature map based on the target DMA configuration information includes:
constructing the target output feature map of a size W*H*M based on the target DMA configuration information, wherein the target output feature map comprises all 0s, the starting address is C, W is the width of the original output feature map, H is the height of the original output feature map, and M is the sum of the number of channels of all original output feature maps.

12. The method of claim 9, wherein constructing the target output feature map based on the target DMA configuration information includes:
reading specific pattern information from a specific storage location, and constructing the target output feature map corresponding to the specific pattern information based on the target DMA configuration information.

13. The method of claim 12, wherein constructing the target output feature map corresponding to the specific pattern information based on the target DMA configuration information includes:
constructing the target output feature map of all 0s based on the target DMA configuration information.

14. A data processing method for a direct memory access (DMA) controller, comprising:
dividing an original input feature map into two or more sub-input feature maps;
acquiring feature information of each sub-input feature map and generating DMA read configuration information and DMA write configuration information of the sub-input feature map based on the feature information of each sub-input feature map; and
reading input data from the sub-input feature map based on the DMA read configuration information of the sub-input feature map and storing the read input data to a target input feature map corresponding to the sub-input feature map based on the DMA write configuration information of the sub-input feature map for each sub-input feature map, wherein
different sub-input feature maps correspond to different target input feature maps.

15. The method of claim 14, wherein the feature information includes a width W and a height H of the sub-input feature map, and
generating the DMA read configuration information of the sub-input feature map based on the feature information of the sub-input feature map includes generating an X-direction count configuration based on the width W of the sub-input feature map; a Y-direction count configuration based on the height H of the sub-input feature map; and a X-direction stride configuration and a Y-direction stride configuration based on a value.

16. The method of claim 15, wherein the feature information further includes a number of channels N of the sub-input feature map, and
generating the DMA read configuration information of the sub-input feature map based on the feature information of the sub-input feature map includes generating a Z-direction count configuration based on the number of channels N, and a Z-direction stride configuration based on the value.

17. The method of claim 14, wherein the feature information includes the width W and height H of the sub-input feature map, and
generating the DMA write configuration information of the sub-input feature map based on the feature information of the sub-input feature map includes generating the X-direction count configuration based on the width W of the sub-input feature map; the Y-direction count configuration based on the height H of the sub-input feature map; and the X-direction stride configuration and the Y-direction stride configuration based on the value.

18. The method of claim 17, wherein the feature information further includes the number of channels N of the sub-input feature map, and
generating the DMA write configuration information of the sub-input feature map based on the feature information of the sub-input feature map further includes generating the Z-direction count configuration based on the number of channels N, and the Z-direction stride configuration based on the value.

19. The method of claim 14, further includes:
reading each input data in the sub-input feature map based on the DMA read configuration information of the sub-input feature map starting from a starting address corresponding to the sub-input feature map.

20. A data processing method for a direct memory access (DMA) controller, comprising:
dividing an original input feature map into two or more sub-input feature maps;
generating first DMA read configuration information and first DMA write configuration information of the sub-input feature map based on feature information of each sub-input feature map;
reading input data from the sub-input feature map based on the first DMA read configuration information of the sub-input feature map, and storing the read input data in a target input feature map corresponding to the sub-input feature map based on the first DMA write configuration information of the sub-input feature map for each sub-input feature map;
generating second DMA read configuration information and second DMA write configuration information of the target input feature map based on feature information of each target input feature map; and
reading the input data from the target input feature map based on the second DMA read configuration information of the target input feature map, storing the read input data in the target output feature map based on the second DMA write configuration information of the target input feature map for each target input feature map, wherein
different sub-input feature maps correspond to different target input feature maps.
